(19) United States
(12) Patent Application Publication
(10) Pub. No.: US 2024/0194888 A1
(43) Pub. Date: Jun. 13, 2024

(54) ELECTROCHEMICAL DEVICES UTILIZING MXENE-POLYMER COMPOSITES

(71) Applicant: Giner, Inc., Newton, MA (US)

(72) Inventors: Castro Laicer, Acton, MA (US); Mario Moreira, Hudson, MA (US); Katherine Harrison, Arlington, MA (US)

(21) Appl. No.: 18/286,819

(22) PCT Filed: Apr. 15, 2022
(86) PCT No.: PCT/US22/24958

§ 371 Date: Oct. 13, 2023

Related U.S. Application Data
(60) Provisional application No. 63/175,359, filed on Apr. 15, 2021.

(51) Int. Cl. H01M 4/62; H01G 11/48; H01M 4/134; H01M 4/136; H01M 4/36; H01M 4/38; H01M 4/58; H01M 10/052; H01M 50/414; H01M 50/431; H01M 50/446; H01M 50/449

(52) U.S. Cl. CPC H01M 4/628; H01G 11/48; H01M 4/134; H01M 4/136; H01M 4/366; H01M 4/382; H01M 4/5815; H01M 4/624; H01M 10/052; H01M 50/414; H01M 50/431; H01M 50/446; H01M 50/449

(57) ABSTRACT

An electrochemical device includes a cathode, an anode, a separator, and an electrolyte in fluid communication with the cathode, the anode, and the separator, wherein at least one of the cathode, the anode, and the separator is coated with at least one of a blend and a multilayer film of an MXene-polymer composite material.

### RELATED APPLICATION

This application claims the benefit of U.S. Provisional Application No. 63/175,359, filed on 15 Apr. 2021, the relevant teachings of which are incorporated herein by reference in their entirety.

### GOVERNMENT SUPPORT

This invention was made with government support under NASA SBIR Phase I contract numbers 80NSSC19C0374 and 80NSSC18P2073, as well as NASA SBIR Phase II contract numbers 80NSSC19C0179 and 80NSSC20C0093. The government has certain rights in the invention.

### FIELD OF INVENTION

This invention relates to electrochemical devices that employ MXene-polymer composites.

### BACKGROUND

Current, lithium-ion (Li-ion) batteries (LIBs) dominate the market in consumer electronics, electric vehicles, aerospace, aviation, and other applications. However, the highest achievable gravimetric energy density of state-of-the-art (SOA) LIBs (250 Wh/kg cell level, 170 Wh/kg pack level) does not satisfy the requirements of next generation electric vehicle and aerospace applications. The Li—S battery is considered one of the most promising technologies for next generation batteries because of its high theoretical gravimetric energy density (2500 Wh/kg), which is up to five times higher than the theoretical value of today's LIBs. As a cathode, sulfur is a low cost and earth abundant active material with a high theoretical capacity of 1675 mAh/g. Future Li—S cells are estimated to deliver a practical energy density of 400-600 Wh/kg, which is 2-3-fold higher than SOA LIB cells. Despite these benefits, several challenges remain before Li—S batteries can realize their potential. To overcome the poor electrical conductivity of sulfur, Li—S electrodes require high conductive carbon concentrations. In addition, Li—S electrodes also suffer from large volume increases (up to 80%) during cycling after full lithiation. Further, the charge-discharge mechanism of Li—S batteries proceeds through a series of lithium polysulfides (LiPS) intermediates, which causes dissolution of LiPS into the electrolyte. Dissolved LiPS species migrate to the Li metal anode where they form highly resistive deposits on the surface which cause anode degradation.²⁻⁴

Therefore, a need exists for electrochemical devices, such as electrochemical cells and batteries, such as lithium-sulfur batteries, that overcome or minimize the above-referenced problems

### SUMMARY

The invention generally is directed to an electrochemical cell wherein at least one of the cathode, the anode, and the separator is coated with at least one of a blend and a multilayer film of an MXene-polymer composite material.

In one embodiment, the invention is an electrochemical cell that includes a cathode, an anode, a separator, and an electrolyte in fluid communication with the cathode, the anode, and the separator, wherein at least one of the cathode, the anode, and the separator is coated with at least one of a blend and a multilayer film of an MXene-polymer composite material.

This invention has many advantages. For example, when employed in a cathode of a electrochemical cell of the invention, the MXene-polymer composite material mitigates lithium polysulfide dissolution from the cathode. The electrochemical cells of the invention also protect the anode from degradation by the electrolyte of an electrochemical cell of which they are components. Moreover, electrochemical cells of the invention have improved cycle-life performance.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A through 1D are scanning electron microscope (SEM) images of MXene flakes in the prior art ranging in size from <1 μm to 15 μm in size.

FIG. 2A is a schematic representation of a suitable method of the invention of preparing self-healing, LbL-polymer-MXene artificial solid electrolyte interphase (ASEI) on a Li metal anode of the invention.

FIG. 2B is a schematic representation of a method of the invention of preparing an LbL MXene barrier coating on a sulfur cathode electrode.

FIG. 3A is a schematic representation of degradation of a standard lithium (Li) anode during cycling known in the art.

FIG. 3B is a representation of a cycled Li anode stabilized with, LbL-polymer-MXene ASEI coating of the invention.

FIG. 3C is an expanded view showing an artificial solid electrolyte interphase stratified (ASEI) composite structure with an elastic hydrogen-bonded, LbL PAA/PEO (polyacrylic acid/polyethylene oxide) multi-layer and a hard LbL MXene nanosheet top layer of the invention.

FIG. 3D is a representation of the chemical structure of the PAA/PEO polymer layer shown in FIG. 3C.

FIG. 4 is a plot of rheology data of electrodes utilizing MXene as a sulfur host (i.e. a porous electrically conductive material that is impregnated with a sulfur active cathode material) of the invention, and a known Li—S slurry of the prior art without MXenes.

FIG. 5 is a plot of discharge capacity vs cycle life for electrodes utilizing MXene as a sulfur host.

FIG. 6A is a top-down SEM of a known non-coated polyolefin separator.

FIG. 6B is a top-down SEM of a 1-LbL MXene-coated polyolefin separators suitable as a component of an electrochemical cell of the invention.

FIG. 6C is a cross section SEM of a 1-LbL MXene-coated polyolefin separator suitable as a component of an electrochemical cell of the invention.

FIG. 6D is a cross section SEM of a known non-coated polyolefin separator.

FIG. 7 are plots of AC impedance of Li/Li cells with MXene-polymer composite coated separators of the invention and cells with bare polyolefin separators of the prior art.

FIGS. 8A through 8D are plots of coin cell results for Li—S cells with LbL MXene-coated separators of the invention (triangles), compared to baseline cells of the prior art without MXene separator (squares) and SOA baseline cells (circles) of the prior art, showing (FIG. 8A) discharge capacity, (FIG. 8B) % capacity, (FIG. 8C) IR vs. cycle number, and (FIG. 8D) discharge voltage profiles, wherein cells were cycled at a C/4 charge-discharge rate, and wherein the data includes an average of three cells.

FIGS. 9A through 9C are postmortem SEM/EDX analyses of (FIG. 9A) MXene-polymer composite separators of electrochemical cells of the invention, and (FIG. 9B), bare polyolefin separators from cycled Li—S cells, and (FIG. 9C) EDX of bare and MXene-coated separator samples of the invention obtained from a 300×300 μm SEM viewing field area, wherein the separator side facing the sulfur cathode was analyzed.

FIGS. 10A through 10D are plots of cycle tests for MXene-coated sulfur cathode cells of the invention (triangles) and MXene-coated on both the sulfur cathode and separator (circles) of the invention, wherein the cells were cycled at C/4 except for gray data, which was cycled at C/2, and wherein the data includes an average of three cells.

FIG. 11A is a plot of a known Li metal anode foil of the prior art before coating with LbL polymer-MXene ASEI.

FIG. 11B is a plot of a Li metal anode foil after coating with LbL polymer-MXene ASEI, according to one embodiment of electrochemical cells of the invention.

FIG. 12 shows plots of AC impedance measurements for symmetrical cells tested with ASEI-modified Li metal anodes according to one embodiment of electrochemical cells of the invention and bare Li anodes of the prior art, wherein the modeled circuit elements are shown as inserts.

FIGS. 13A through 13D are plots of (FIG. 13A) discharge capacity, (FIG. 13B) capacity retention as a function of cycle number at a C/4 charge-discharge cycling rate for cells assembled with polymer-MXene ASEI-modified Li anodes according to one embodiment of electrochemical cells of the invention, and bare Li metal anodes, voltage profiles of (FIG. 13C) ASEI-protected cells of on embodiment of the invention, and (FIG. 13D) baseline cells with bare Li anodes of the prior art.

### DETAILED DESCRIPTION

The invention generally is directed to an electrochemical cell wherein at least one of the cathode, the anode, and the separator is coated with at least one of a blend and a multilayer film of an MXene-polymer composite material.

In one embodiment, the invention is an electrochemical cell that includes a cathode, an anode, a separator between the cathode and the anode, and an electrolyte in fluid communication with the cathode, the anode, and the separator, wherein at least one of the cathode, the anode, and the separator is coated with at least one of a blend and a multilayer film of an MXene-polymer composite material.

In a specific embodiment, the electrochemical cell is selected from the group consisting of a lithium-sulfur battery, a lithium-metal battery, a lithium-ion battery, a sodium-sulfur battery, a magnesium-sulfur battery, an aluminum-sulfur battery, a lithium-air battery, and a capacitor.

The anode, in any particular embodiment, is selected from the group consisting of a graphitic carbon anode, a silicon anode, a lithium metal anode, a lithium alloy anode, a sodium metal anode, a magnesium metal anode, and an aluminum metal anode. In a specific embodiment, the anode includes the MXene-polymer composite material, and the MXene-polymer composite material is a solid electrolyte interphase. In one such embodiment, the MXene-polymer composite material of the anode is a blend of MXene and polymer components of the MXene-polymer composite material coating. In another such embodiment, the MXene-polymer composite material of the anode includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member of the group consisting of carbon and nitrogen, and Tₓ is at least one surface functional groups selected from the group consisting of an alkoxide, a carboxylate, a halide, a hydroxide, a hydride, an oxide, a sub-oxide, a nitride, a sub-nitride, a sulfide, and a thiol. Specific examples of such MXene-polymer composite materials of the anode include at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, Ta₄C₃Tₓ, and Mo₂Ti₂C₃Tₓ.

In particular embodiments, the MXene-polymer composite material of the anode includes at least one member of the polymer group consisting of a poly(acrylic acid), poly(styrene sulfonate), poly(ethylene oxide), branched poly(ethyleneimine) linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

In specific embodiments, the MXene-polymer composite material od the anode includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

Optionally, the MXene-polymer composite material of the anode includes a crosslinked polymer.

In another embodiment, the cathode includes the MXene-polymer composite material. In one such embodiment, the MXene-polymer composite material of the cathode is a blend of MXene and polymer components of the MXene-polymer composite material.

In a specific embodiment, the MXene-polymer composite material of the cathode includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol. Specific examples of MXene-polymer composite materials of the cathode include at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

In particular embodiments, the MXene-polymer composite material of the cathode includes at least one member of the group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

In specific embodiments, the MXene-polymer composite material of the cathode includes at least one of graphene oxide, single-walled carbon nanotubes, multi-walled carbon nanotubes, SiO₂, and inorganic nanoparticles including at least one member of the group consisting of SiO₂, TiO₂, ZnO, Al₂O₃, CeO₂, Fe₂O₃, Fe₃O₄, and Al(OH)₃.

Optionally, the MXene-polymer composite material of the cathode includes a crosslinked polymer.

In still another embodiment, the cathode includes an MXene and at least one sulfur component. In one such embodiment, the MXene of the cathode has a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol. Examples of such embodiments are cathodes that include at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC2Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

In still another embodiment, the invention is an electrochemical cell wherein the cathode includes at least one of a blend and a multilayer film of an MXene-polymer composite material. In a specific embodiment, the MXene of the cathode has a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol. In this embodiment, examples of suitable MXenes of the cathode include at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

In yet another embodiment, the invention is an electrochemical cell wherein the separator includes at least one of a blend and a multilayer film of an MXene-polymer composite material. In one such embodiment, the MXene-polymer composite material of the separator is a blend of MXene and polymer components of the MXene-polymer composite material.

In one embodiment, the MXene-polymer composite material on the separator includes at least one nanosheet of MXenes with a general formula of Mₙ₊₁Xₙ Tₓ (n=1, 2, or 3), where M represents a transition metal selected from a Group IIIB metal, Group IVB metal, Group VB, or Group VIB metal, X is at least one member of the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol. Examples of suitable MXene-polymer composites include those having at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

In specific embodiments, the MXene-polymer composite material of the separator includes at least one member of the polymer group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

In particular embodiments, the MXene-polymer composite material of the separator includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

Optionally, the the MXene-polymer composite material of the separator includes a crosslinked polymer.

In still another embodiment, the invention is an electrochemical cell that includes an MXene-polymer composite material of a blend of an MXene and polymer components of the MXene-polymer composite material. Optionally, in specific such embodiments, at least two of the anode, the cathode, and the separator include the MXene and the polymer components of the MXene-polymer composite material.

Particular embodiments where the MXene-polymer composite material includes a blend of MXene and polymer components of the MXene-polymer composite material, at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol. Examples of suitable MXene-polymer composite materials include at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

In one embodiment, the MXene-polymer composite material blend includes at least one member of the polymer group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene chloride, poly(vinylidene fluoride-hexafluoropropylene), and copolymers thereof.

Optionally, in specific embodiments, the MXene-polymer composite material blend includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

Also optionally, the MXene-polymer composite material can include a crosslinked polymer

In still another embodiment of the electrochemical cell of the invention, at least two of the anode, the cathode, and the separator includes an MXene-polymer composite material. In one such embodiment, the MXene-polymer composite material of at least two of the anode, the cathode, and the separator each independently includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member of the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol. Specific examples of MXene-polymer composite of at least two of the anode, the cathode, and the separator each independently includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

In particular embodiments, wherein at least two of anode, the cathode, and separator include the MXene-polymer composite material, the MXene-polymer composite material includes at least one member of the polymer group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

In particular embodiments, wherein at least two of anode, the cathode, and separator include the MXene-polymer composite material, the MXene-polymer composite material of at least one of the anode, the cathode, and the separator each independently includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

Optionally, wherein at least two of the anode, the cathode, and separator include the MXene-polymer composite material, the MXene-polymer composite material of at least one of the anode, the cathode, and the separator each independently includes a crosslinked polymer.

The benefits of this invention include improvements in safety and electrochemical performance of Li—S batteries and employs discovered two-dimensional metal-carbide and nitride (MXene) materials that are incorporated into the Li—S cell using a variety of methods to reduce LiPS dissolution, electrolyte decomposition, and degradation of the lithium metal anode. Discovered in 2011, MXenes are a new class of crystalline 2D materials with a general formula of Mₙ₊₁XₙTₓ (n=1, 2, or 3), where M represents an early transition metal, X is carbon and/or nitrogen, and Tₓ represents surface functional groups (e.g., OH, O, F).⁵ MXenes (M₂X, M₃X₂, and M₄X₃), contain n+1 layers of M covering n layers of X atoms in an [MX]ₙM arrangement. Examples of MXenes include Ti₂CTₓ, Ti₃C₂Tₓ, and Nb₄C₃Tₓ⁶⁻⁸ MXenes can also contain two distinct M elements arranged randomly in the M layers as a solid solution phase, or as an ordered phase comprising layers of one transition metal sandwiched between layers of a second transition metal.^{5-6, 9}

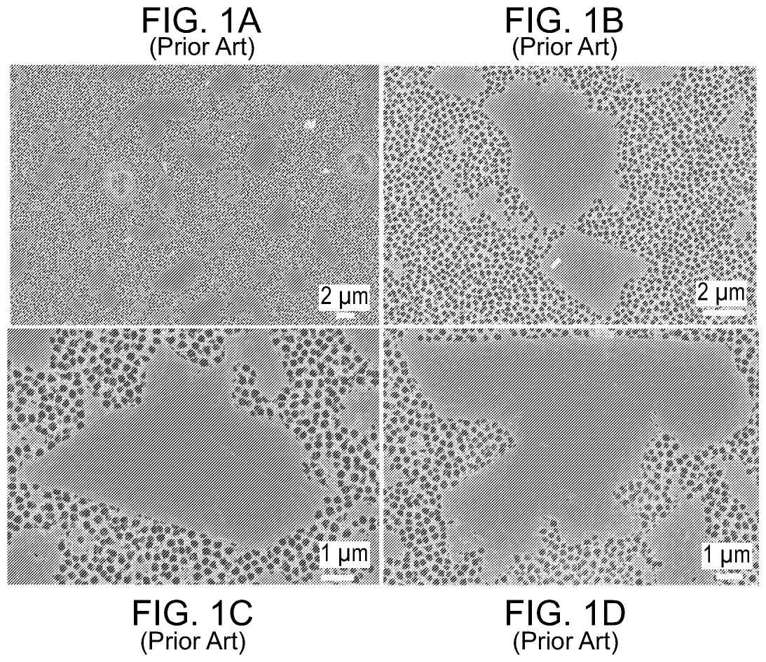

MXenes can be prepared by wet chemical etching of a MAX phase powder precursor (e.g., M₃AC₂) with HF⁸ or a mixture of a strong acid and a fluoride salt (HCl/LiF).¹⁰ After etching, MXenes can be delaminated by intercalation with various polar organic molecules (e.g., DMSO¹¹) or large organic base molecules (tetrabutylammonium hydroxide, TBAOH¹²) to achieve suspensions of single-layer or few-layer nanosheets. Etching in the presence of a metal halide such as a mixture of HCl and LiF, leads to intercalation of metal cations (e.g., Li⁺) within the layered structure. Therefore, delamination is achieved without additional intercalation molecules by simply raising the solution pH to almost neutral and employing mild mechanical agitation (e.g., shaking).¹³⁻¹⁴ The resulting aqueous suspensions are stable and do not aggregate because of the negative zeta potential of the MXene nanosheets. MXenes synthesized by HF-containing solutions contain a mixture of —OH, —O, and —F surface functional groups.¹⁵⁻¹⁶ As-produced single-layer MXenes contain intrinsic point defects, such as atomic vacancies.^{13, 17} In general, milder synthesis conditions promote production of larger MXene flakes with fewer atomic defects. For example, nanometer-thick Ti₃C₂Tₓ flakes with lateral dimensions of 3-6 μm and minimal defects have been prepared using mild etching and delamination conditions.^{13-14, 18, 19} Representative of images of SEM flakes are shown in FIGS. 1A through ID.

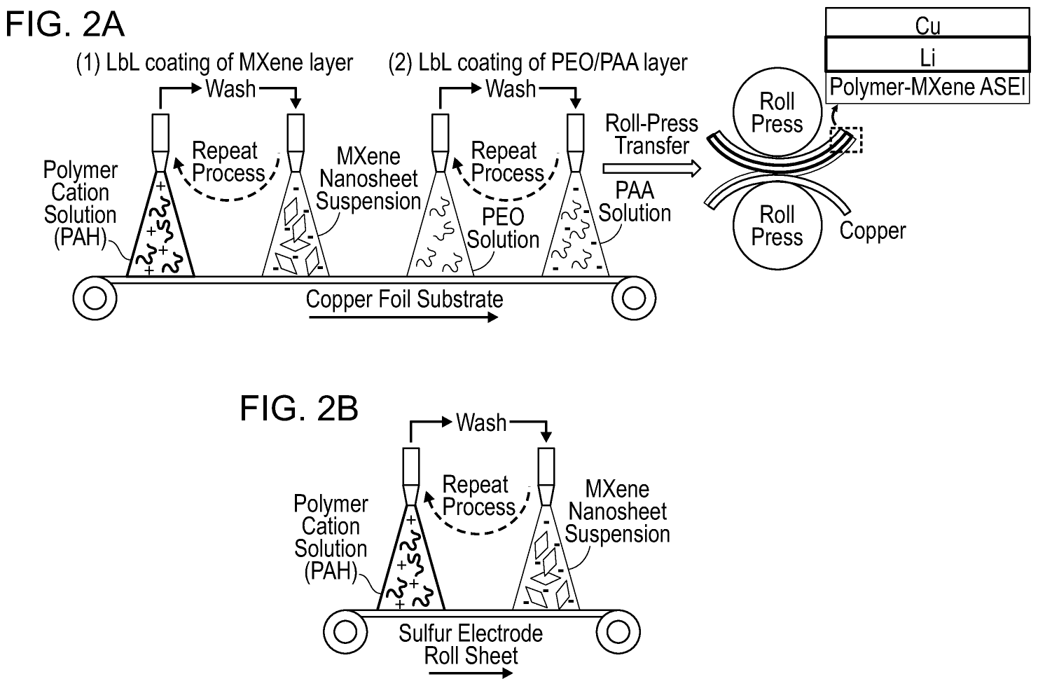

MXenes entrap LiPS via strong Lewis acid-base interactions and the formation of metal-sulfur bonds on MXene surfaces.²⁰ In one method, the negatively-charged MXenes can be paired with a positively charge polymers or other active materials to form a coating which acts as a physical LiPS blocking barrier on the anode, cathode or separator material via the layer-by-layer (LbL) assembly process.^{15-16, 21} The LbL-assembly method is a cyclical coating process in which a charged material is adsorbed onto a substrate as an ultrathin layer, followed by adsorption of an oppositely charged material on top of the first layer.²² This first step constitutes a single bilayer with a thickness on the order of nanometers. The coating of the positive and negative material coating can be repeated multiple times to increase the film thickness. In one instance, the negatively charged MXenes can be paired with a cationic poly(allylamine) HCl (PAH) to form the LbL film. The deposition process can be repeated multiple times until a thicker, multilayer film with the desired thickness is achieved. The electrostatic interactions allow a wide variety of diverse materials to be incorporated into the coating. The coating can be formed by spray coating, spin coating, dip coating, or other deposition techniques, such as are shown in FIGS. 2A and 2B. LbL is an aqueous, low-energy, and room-temperature coating process. This versatile deposition method allows MXene-based coatings to be applied on a variety of substrates including on the sulfur cathode, battery separator, or the Li metal anode. In each case, the MXene-based coating provides a strong interaction with LiPS while enabling conduction of Li⁺ ions during cell charge-discharge cycling.

In one aspect of the invention, MXene flakes may be used as a sulfur host material during the electrode fabrication process. This process may use single, delaminated MXene flakes or non-delaminated MXene material. In this instance, sulfur and MXenes are homogenously mixed together in a desired ratio. MXenes may be used as the only sulfur host or combined with other porous carbons to act as the sulfur host. In some cases, heat may be used to facilitate sulfur infiltration into the MXene host. This material may then be further mixed with a carbon additive, such as Super P and a binder material such as polyvinylidene fluoride (PVDF) to form the electrode slurry. The slurry may be prepared in DI H₂O or with a polar organic solvent such as but not limited to N-Methyl-2-Pyrrolidone (NMP), ethanol, dimethyl formamide (DMF), or propylene carbonate (PC). The slurry is then coated via methods such as doctor blade, slot-die, spray coating, gravure coating, or other methods suitable for battery electrode coatings.

The MXenes may also be used as an electrode conductive additive. During the slurry mixing process, MXenes are added to the slurry to act as electrically conducting agents and to provide enhanced LiPS entrapment. This approach is distinct from using MXenes as a sulfur host since the concentration of conductive additives is traditionally much lower and sulfur is not incorporated into the MXene pore structure.

The described LbL coating manufacturing process is versatile and may be used to apply coatings on the cathode, anode, or separator. To coat the Li metal anode, the deposition process must first take place on a sacrificial substrate, such as Cu foil or a quick release surface such as fluorinated ethylene propylene (FEP), as shown in FIG. 2A. The coated film is then placed face to face with Li metal and fed through a roll-press device to transfer the MXene film to the Li metal surface. In other methods, the MXene film can be applied directly to the sulfur cathode, as shown in FIG. 2B. In this process, the sulfur cathode can be replaced with the battery separator. In each instance, the MXene-based film entraps LiPS, preventing degradation of the Li metal anode.

In another aspect of this invention, the MXene coating can incorporate several different polymer pairings. PAH can be replaced with another cationic polymer such as branched poly(ethyleneimine) (PEI) or linear PEI to form the desired number of bilayers. Other cationic polymers can also be used.

In another aspect, MXenes can be incorporated into the LbL coating at a lower frequency to reduce loading. In this instance, MXenes would be intermittently substituted with a negatively charged component during the film deposition process. In this case, the amount of MXenes deposited in the film would be limited to reduce film weight or thickness. Negatively charge replacements could include poly(acrylic acid) (PAA) or poly(styrene sulfonate) (PSS) to accomplish LbL buildup, with MXenes being incorporated at the desired frequency.

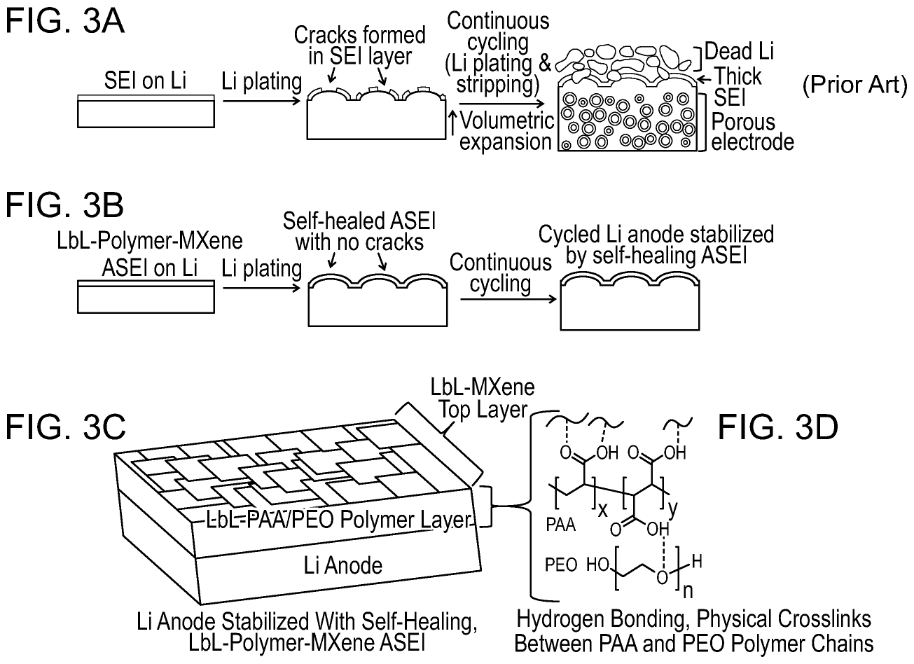

In another aspect of this invention, the MXene coatings can be paired with a self-healing polymer layer comprised of poly(ethylene oxide) and PAA. The PEO/PAA polymer pairing can be deposited before, after, or interspersed with the MXene deposition. This self-healing layer can help repair cracks that form in the coating due to volume expansion of the sulfur cathode and Li anode during cycling. When this film is deposited onto the Li metal anode, it can form an artificial solid-electrolyte-interphase (ASEI), as shown in FIGS. 3A through 3D. During normal Li—S cycling, growth of the solid-electrolyte-interphase (SEI) leads to dead Li, a porous electrode and cycling failure, as shown in FIG. 3A.² By depositing the self-healing ASEI MXene layer on the Li metal surface, the SEI can self-heal and limit anode degradation, as shown in FIG. 3B. A schematic of the coated Li metal is shown in FIG. 3C and the structure formulas of PEO/PAA polymers are shown in FIG. 3D.

In another aspect of this invention, additional components can be added to the LbL process to impart additional functionality. Graphene oxide (GO) can be used to improve film mechanical stability of the film.²³ In the LbL film deposition process, GO can be used as a negatively charged component and can be added as the initial layer, interspersed throughout the coating, or used as the terminating layer. In each case, mechanical stability of the film can be improved to help withstand volumetric changes in the cell during cycling.

In another aspect of the coating, additional methods may be used to improve substrate-coating interaction of the first LbL layer. In one instance, plasma treatment of the substrate may be used to increase the surface energy of the substrate and improve substrate-film interaction. In another instance, PEI may be used to form a stronger initial layer prior to further LbL film deposition. In another instance, dip-coating may be used to form the initial LbL layers where further layers are deposited via spray coating.

In another aspect of the coating, cross-linking may be used to strengthen the mechanical properties of the film. In this instance, a heat treatment step up to 200° C. can be used to cross-link layers of the film for improved mechanical stability. Other cross-linking methods, such a UV-curing or chemical cross linking can also be used. This step can be performed after initial layers are deposited or after the film deposition is completed.

In another aspect of the film, a decal layer can be deposited to facilitate film transfer via the roll-press method onto the Li metal anode. In this aspect, a number of PEO/PAA bilayers can first be deposited, followed by increasing number MXene-based bilayers. This PEO/PAA layer has weaker adhesion to the substrate, leading to easier delamination during the roll press method and more uniform transfer of the coating from the initial substrate to the Li metal. In this method, the PEO/PAA layer is preserved and is transferred to the Li metal anode as well.

MXenes can be also deposited with an ionomer, such as perfluorosulfonic acid (PFSA). In this instance, the PFSA acts as ionically conductive material that has strong interaction with LiPS. The ionomer can be incorporated as an additional component in the LbL process, exist in the electrode as a binder, or may be combined with MXenes in the continuous spraying approach. The combination of strong LiPS interaction between the two materials results in improved LiPS entrapment without loss of electrical or ionic conductivity.

In another aspect of the coating process, MXenes can be deposited without using the LbL deposition method. In this process, MXenes can be deposited directly onto the target substrate, and a combination of other polymers and/or functional components can be incorporated by using a continuous spraying method. This method is distinctly different from the previously described LbL approach as it does not rely on the alternating deposition of oppositely charged molecules. In one instance, MXenes and the desired polymers are homogenously mixed in solvent and then coated onto the desired substrate. The solvent can be aqueous or organic, including DI water, NMP, DMSO, ethanol, DMF or PC. The coating method may be spray coating, doctor blade coating, dip coating or similar coating methods.

In another aspect of the invention, MXenes coatings may be fabricated as a free-standing film. This physical barrier can prevent LiPS from reaching the Li metal anode. This film thickness can range from the nanometer scale to several microns in thickness. This freestanding membrane can be incorporated into the cell on the cathode side, anode side or both. The freestanding film may also include additional additives such as GO for enhanced mechanical stability or any of the previously discussed polymers for additional cohesion between MXene flakes. The anode used in this invention can also comprise a graphitic anode, silicon anode, or other anodes capable of storing Li ions in rechargeable batteries.

The invention described utilizes MXene flakes in a variety of methods in a Li—S battery cell to prevent LiPS from causing electrolyte decomposition and degradation at the Li metal anode surface. MXenes are a new class of two-dimensional titanium carbide material with a customizable synthesis technique. During charge-discharge cycling of the Li—S battery, the MXene flakes act as a physical barrier to prevent LiPS from reaching the Li metal anode and cause electrolyte decomposition and anode degradation. In addition to a physical barrier, the MXene flakes also have a strong Lewis acid-base interaction with LiPS, entrapping them because they can cause degradation of the Li metal anode. When deposited on the anode, the MXenes form an ASEI which can be combined with a self-healing film of PEO/PAA discussed in previous sections. The self-healing polymer-MXene ASEI is designed to stabilize cycling of the Li metal anode by providing the following key functions: (1) the MXenes improves the mechanical durability of the ASEI film and provides a physical protective barrier between the Li metal and electrolyte; (2) the MXenes enhance electrical and Li-ion conductivity of the ASEI to create more uniform local current densities and Li-ion flux over the rough Li surface, thus promoting a more homogenous Li plating/stripping and suppressing dendrite growth during cycling; and (3) the ASEI incorporates a viscoelastic, hydrogen-bonding polymer layer that enables spontaneous self-healing to repair cracks and mechanical damage formed in the coating during cycling of the Li anode. MXene flakes used in this method can be processed to fine-tune flake morphology. In one method, MXene flakes can be sub-micron in diameter. In another method, MXene flakes can be 1 μm to 15 μm or larger, as can be seen in FIGS. 1A through 1B. Larger sized flakes may provide more mechanical film stability while smaller flake sizes may provide better film uniformity due to improved packing density. Films comprised of MXene flakes with or without polymers or additional additives can be added to the cathode, separator, or anode. These films can also be added in multiple places in a Li—S, such as the cathode and anode, cathode and separator, anode and separator, or cathode, anode and separator.

One method for using MXene in Li—S batteries is to utilize the MXenes as a porous sulfur host. In a typical Li—S battery, a porous carbonaceous material such as Ketjen Black (EC600JD, Lion Specialty Chemicals Company) is utilized as a sulfur host. This allows for intimate contact between the active sulfur and carbon, which is essential due to the poor electronic conductivity of sulfur. The porous host allows for volume expansion and helps constrain LiPS that form during typical cycling. However, traditional methods are insufficient, resulting in poor cycle life. MXenes can fully or partially replace this host. The MXene materials can form an accordion-like structure with void space for sulfur infiltration. This host has enhanced LiPS interaction, preventing migration to the Li anode. MXenes entrap LiPS via strong Lewis Acid-base interactions and the formation of metal-sulfur bonds on MXene surfaces.²⁰ The existence of strong metal-sulfur interactions has been supported by X-ray photoelectron spectroscopy (XPS) and computational analysis of MXene phases (Ti₂CTₓ, Ti₃C₂Tₓ, Ti₃CNTₓ) in contact with LiPS species.²⁴ This entrapment enables selective transport of Li+ ions via intercalation through the layered MXene structure. Traditional carbon materials, such as Ketjen Black (EC600JD Lion Specialty Chemicals Company) only act as a physical constraint without significant chemical interaction. As a host, elemental sulfur is blended with MXenes and may be subject to a heating step to facilitate infusion of the sulfur into the MXene structure. This can allow extremely high sulfur content in electrodes of up to 80%. MXenes may be supplemented by another porous carbon, such as Ketjen Black (EC600JD Lion Specialty Chemicals Company), to improve the porosity of the host material. The sulfur infused material can then be processed via traditional methods to form the Li—S electrode.

In addition to being used a host, the MXenes can be used as a conductive additive. Due to the poor electronic conductivity of sulfur, high concentrations of carbon (such as Super P, Alfa Aesar H30253-14) need to be used in Li—S electrodes. By fully or partially replacing traditional carbon additive materials, such as Super P (Alfa Aesar H30253-14), the electrical conductivity of the electrode can be improved or the total carbon content of the electrode can be reduced, leading to improved energy density and high-rate capability. In addition, the high carbon content of Li—S electrodes causes issues with mechanical integrity, as the highly porous carbon materials absorb significant volumes of solvent during the slurry mixing process and suffer from significant volume changes during drying, causing electrode cracking and poor overall mechanical stability. This MXene additive will also have improved LiPS interaction, entrapping LiPS before they can migrate and decompose the Li metal. Utilizing MXenes as a conductive additive can reduce the conductive carbon content in electrodes to 10% or less, while typical Li—S electrodes need >20% carbon to improve electrical conductivity.

In the described methods above, electrodes may consist of a variety of conductive additives including Super P (Alfa Aesar H30253-14), Ketjen Black (EC600JD Lion Specialty Chemicals company), acetylene black (Soltex Acetylene Black 50%-01), Black Pearls 2000 (BP-2000, Cabot) or other like carbon black materials. The electrodes navy be hold together utilizing binders such as PVDF, polyvinylpynolidone (PVP), polytetrafluorethylene (PTFE), or carboxymethylcellulose (CMC) with styrene-butadiene rubber (SBR).

In another method, MXenes can be incorporated into a coating. The coating described in this invention is manufactured via spray, dip or spin coating MXene flakes which can be paired with oppositely charged polymers forming an LbL film assembly, as shown in FIG. 2. This assembly can be as thin as a single bilayer (<1 μm thick) or contain several hundred pairings (1-500 μm thick or greater). The film thickness is scalable with bilayer count. The flakes can also be deposited without relying on the LbL process in a continuous spraying method that does not rely on interaction between oppositely charged materials. The film may consist of multiple polymers and other components to impart additional functionality to the coating. Polymers may include PAH, PEO, PAA, PSS, PEI. Additional functional materials may be added, such as graphene or GO. The film deposition method may be aqueous or include polar organic solvents such as NMP, DMSO, ethanol, DMF or PC. The coating may be directly applied to the cathode, separator or to an intermediate substrate to then be transferred to the Li metal surface. In this coating method, a charged material, such as the negatively charged MXene, is deposited onto the substrate, followed by washing before the deposition of an oppositely charged material, such as a positively charged polymer (PAH). This process is then repeated until the desired film thickness is achieved. The film deposition processes can be integrated into existing high-volume, roll-to-roll battery electrode production lines via the spray coating technique. The resulting film provides a polysulfide-blocking layer due to the Lewis-base interaction of the MXene flakes with LiPS resulting in improved electrochemical performance. These advantages include a protected Li metal anode with reduced degradation and electrolyte decomposition at the Li metal anode surface.

LbL assembly is a highly customizable, water-based deposition process that can be used to fabricate complex films in a variety of methods. Examples of LbL film deposition techniques include dipping, spinning, spraying, filtration, and even high volume, roll-to-roll techniques. The chosen LbL coating method is a cyclical process in which a charged material is adsorbed onto a substrate, followed by washing, before an oppositely charged material is adsorbed on top of the first layer. This first step constitutes a single bilayer with a thickness on the order of nanometers. Increasing the bilayer count can linearly increase the thickness and several micron thick coatings are achievable. The deposition process can be repeated multiple times until a thicker, multilayer film with the desired thickness is achieved. In this invention, the coatings are fabricated via the LbL deposition process in which alternating layers of oppositely charged materials are deposited with rinsing steps between. MXenes have a negative charge and can be applied in this method as one of the charged materials. The oppositely charged material may be a polymer or other active materials. The two oppositely charged materials are held together via electrostatic or hydrogen bonding interaction. These coatings can be deposited onto the Li—S cathode, separator, or onto a quick-release substrate to be later transferred to the surface of a Li metal anode. After or during the deposition process, the coating can be cross-linked to further improve mechanical stability. The cross-linking step may include a thermal treatment up to 200° C. for a period of 24 hours. The cross-linking step may also include the addition of a photo-initiator, such as 4,4′-diazostilbene-2,2′disulfonic acid disodium salt, followed by UV exposure.

LbL films can be comprised of a variety of materials. Polymers that can be used in LbL coatings include but are not limited to PAH, PEI, PEO, PAA, poly(3,4-ethylenedioxythioponee) (PEDOT), poly(diallyldimethylammonium chloride), poly(acrylic acid-ran-vinylbenzyl acrylate) (PAArVBA)²⁵ (PDADMAC),²⁶ polylysine (PLL), hyaluronic acid (HA), chitosan, poly(vinyl sulfate) (PVS), dextran sulfate (DS)²⁷ poly methyl methyacrylate (PMMA), PFSA or poly(diallyldimethyl ammoniun) chloride (PDDA). GO may be incorporated to provide additional mechanical support. GO may be used as a negatively charged component or may be modified to produce a positive charge. Examples of this modification include introducing amine groups²⁸ or modification with polyethylene glycol or PDDA²⁹. Other nanomaterials may be incorporated into the coating for added functionality. Graphene may also be used to enhance electronic conductivity. Metal nanoparticles such as silver, gold, platinum and palladium may be added for improved electronic conductivity.³⁰ Carbon nanotubes (CNTs) including single wall carbon nanotubes (SWCNTs) and multi-walled carbon nanotubes (MWCNTS) may be incorporated for improvement mechanical stability, flexibility and electronic conductivity. CNTs may be incorporated with a neutral charge, or functionalized, such as via carboxylation, to provide a negative charge or via chlorination to produce a positive charge for LbL film assembly³¹⁻³². Ceramic particles including clay, SiO₂ or TiO₂ may be added to improve thermal conductivity or provide mechanical reinforcement of the LbL films for improved durability and resilience to volume change. A continuous roll-to-roll coating machine can be used with a continuous film deposition method to fabricate large scale LbL coatings on the desired substrate.

This process is versatile and may incorporate a variety of LbL components. MXenes are used due to their unique mechanical properties including electronic conductivity, mechanical stability and strong interaction with lithium polysulfide species. Graphene oxide can be used to further enhance the mechanical stability. PAH can be used as a cationic polymer for LbL buildup. PAH holds a cationic charge at a neutral pH, which is compatible with Li—S electrodes for film buildup on the Li—S electrode surface, as Li—S electrodes are sensitive to pH. PEO and PAA can be deposited as a self-healing polymer pair. This pair can repair cracks that form in the film due to volume expansion during cycling. This polymer pair may also act to improve adhesion of other LbL components to the desired substrate. This polymer pair may also be used to help facilitate the film transfer of the LbL coating from an initial substrate to the Li metal anode via the film transfer method. PEI may be used to form a strong initial layer with the desired substrate.

MXene coatings may be deposited without using the LbL process. In this instance, suspensions of MXene flakes are applied via a continuous spraying method to the desired substrate. Polymers, such as the previously described PAH, PEI, PEO, PAA, PEDOT, PAArV-BA, PDADMAC, PLL, HA, chitosan, PVS, DS, PMMA or PDDA may be added to the spraying solution to help the materials adhere to the substrate and act as a matrix. Additionally, polymers without charge such as PVDF, CMC, with SBR, polyvinyl alcohol (PVA) or PFSA can be used to help coatings adhere to the substrate. GO may be included for improved mechanical stability of the film. Additional nanomaterials may also be added. Graphene and other nanoparticles including silver, gold, platinum and palladium may be added to improve electronical conductivity. SWCNTs and MWCNTs may be included for improved mechanical stability, flexibility and electronic conductivity. Ceramic particles such as clay, SiO2 or TiO2 may be added for improved thermal stability or provide further mechanical stability. Alternatively, an initial polymer layer may be deposited via either LbL process or continuous spraying process to provide improved adhesion of the MXene flakes to the substrate. Following deposition of MXenes, additional layers of polymers and/or other components may be applied on top of the existing MXene film to further improve functionality.

To coat the Li metal anode, a film transfer method may be used, such as is shown in FIG. 2. Li metal quickly hydrolyzes in the presence of water, forming a non-conductive Li—OH film that cannot be used in Li—S batteries. Therefore, directly coating the Li metal anode with aqueous solutions is not possible. To apply MXene coatings to the Li metal surface, a roll-press transfer method can be used. MXene coatings can be applied to an initial, substrate from which the film can be easily released, such a Cu foil or a low surface energy substrate such as fluorinated polymer film (FEP). After deposition, the film is placed face-to-face with the Li metal and fed through a calendar roll-press device. The compression of the calendaring process causes the deposited film to delaminate from the initial substrate and transfer as a cohesive film to the Li metal surface. In some cases, heat may be used during calendaring to facilitate the film transfer. Initial layers with weak substrate adhesion may be deposited to aid in the delamination process, such as PEO/PAA.

The MXene films described in this invention may be coated onto the battery separator. They may be coated onto the cathode side, anode side, or both sides. The coating method may include spray coating, dip coating, spin coating, doctor-blade coating, or other methods described in this section. The battery separator may be made of polyolefin, cellulose, ceramic, glass, nylon, cotton, polyester, polyvinyl, rubber, PTFE or like materials. The separator may undergo a plasma treatment step prior to coating to aid in film adhesion. The coating method may incorporate LbL film assembly and utilize the associated polymers as described in previous sections. The coating may also be applied without using the LbL method using techniques and polymers described in the previous sections. The battery separator coatings may include additional materials including graphene, GO, CNTs, metal particles and ceramic particles describe in the previous sections.

The following exemplification is intended to be representative and not limiting in any way.

### Example 1

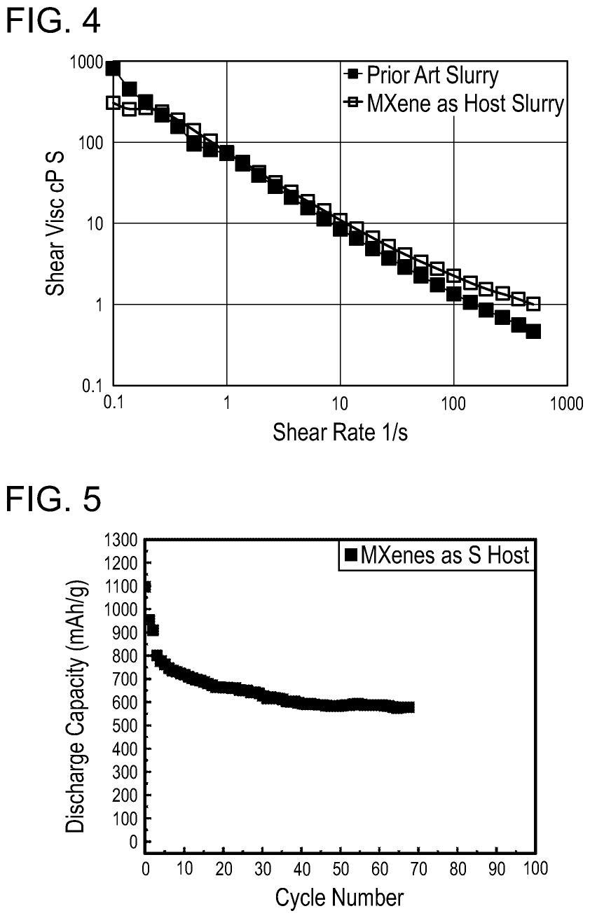

1a. MXenes in Li—S Electrodes as Sulfur Host. Bulk MXene material suspended in water is vacuum dried at 100° C. to remove moisture prior to processing. MXenes are sonicated, centrifuged and rinsed repeatedly to remove residual contaminants from the synthesis process. Ratios of sulfur (Sigma Aldrich 13825-1KG-R) and MXene were mixed overnight with mixing media to form a homogenous blend of materials. Ratios of sulfur to MXene range from 10:90 to 90:10 weight %. After confirming a homogenous dispersion, the MXene and sulfur mix are subject to a melt infusion step. In this step, the homogenous mixture was heated to 155° for 18 hours overnight before allowing to cool overnight. This process partially melts the sulfur and promotes infusion of sulfur into the pores of the MXenes. The blended host material is then incorporated into the slurry via traditional mixing methods. The host material is blended with additional carbon additives (Super P, Alfa Aesar H30253-14) and carbon nanotubes (CNTs) and binder (Solef 5130 Solvay) to form the electrode slurry. The sulfur content in the electrode ranges from 40% to 90%. Conductive additive ranges from 1% to 30%. Binder concentration ranges from 2% to 25%. The slurry can be aqueous or organic. Rheology measurements were taken and compared to Li—S slurries made using traditional carbonaceous materials, as shown in FIG. 4. The slurry with MXenes as host shows similar viscosity values as traditional slurries, indicating there is adequate dispersion and no significant changes to the rheological behavior caused by MXenes. The slurry is then coated via traditional methods such as doctor blade technique onto an aluminum current collector. The sulfur content in the electrode can be up to 90 wt % or higher. The electrode can be coated to a sulfur loading of up to of 50 mg/cm² or higher. The resulting electrode shows excellent adhesion to the current collector.

1b. Evaluation of MXenes in Electrodes. The charge-discharge performance of Li—S electrodes utilizing MXene as a sulfur host was evaluated, the results of which are shown in FIG. 5. MXene electrodes were tested in coin cell batteries and cycled against a Li metal anode. The electrolyte used was 1.0 M Lithium bis(trifluoromethanesulfonyl)imide (LiTFSI), 0.3 M LiNO3 in 1/1 v/v 1 3-dioxolane (DOL):dimethyl ether (DME). Cells underwent three formation cycles at a C/20 rate, followed by cycling at a C/5 rate. Data shown represents an average of three cells. Cells with MXene as the sulfur host material achieve between 900 and 1100 mAh/g S during C/20 cycling, indicating excellent sulfur utilization. During continued C/5 cycling, cells achieve between 800-600 mAh/g.

### Example 2. MXenes in Coatings

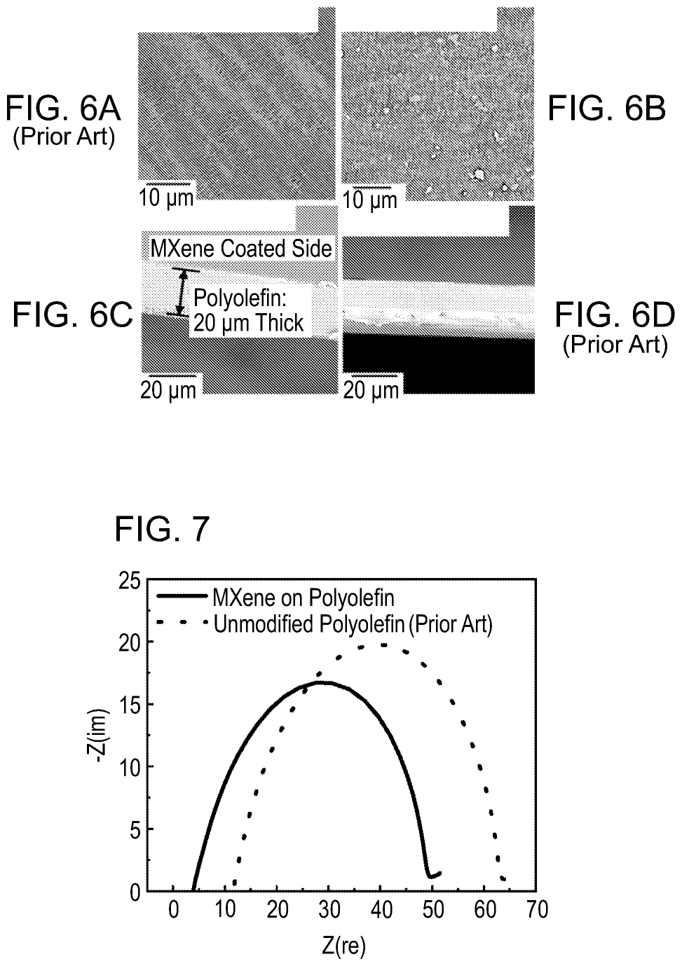

2a. Fabrication of MXene-Polymer Coatings on Li—S Separators. LbL deposition was used to fabricate MXene-based coating onto separators. Concentrated MXene solutions were diluted with deionized water (DI) to a concentration of 0.2 mg/ml. PAH in DI was used at a concentration of 0.2 mg/ml. PAH and rinse solutions were pH adjusted to a value of 7.4. Separators were plasma treated for 30 seconds to help facilitate LbL buildup. After plasma treatment, separators were submerged in PAH solution for 10 minutes, followed by a 5-minute rinsing step in DI. The substrate was then hung vertically and spray coating was used to performed LbL deposition. MXene and PAH solutions were alternately sprayed for 10 seconds each with 10 seconds of rinsing in between until the desired number of bilayers was reached. Up to 40 bilayers was applied to the surface of the separator. High magnification SEM images of MXenes coated onto polyolefin are shown in FIGS. 6A through 6D, showing uniform, ultra-thin (<1 μm) coatings. Minimization of MXene coating thickness and areal mass is important for optimizing gravimetric and volumetric energy density of the assembled Li—S cell. The produced LbL MXene coatings are also highly durable, demonstrating strong adhesion to substrate layers even after extensive electrolyte soak and flexibility bending tests. Additionally, AC impedance measurements on symmetrical Li/Li cells assembled with MXene-coated and bare polyolefin separators, show that Li-ion conductivity is uninhibited with MXene modification. In fact, conductivity increased slightly for MXene-coated separators (4×10⁻³ S/cm) compared to bare separator samples (3×10⁻³ S/cm), as can be seen in FIG. 7.

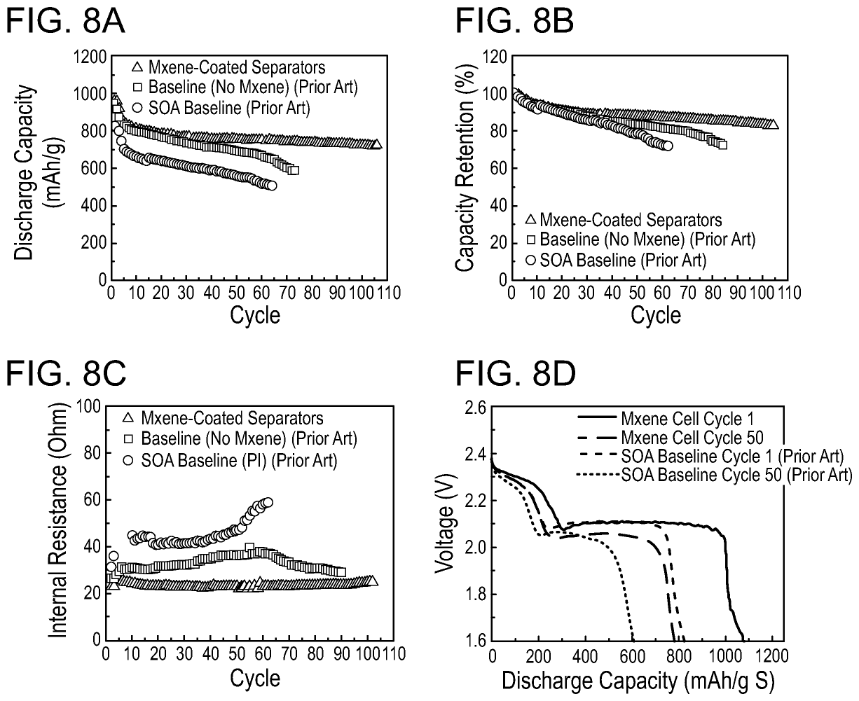

2b. Electrochemical Evaluation of MXene-Polymer coatings on Separators. Cycling results of Li—S cells with LbL MXene-modified separators are shown in FIGS. 8A through 8D. The sulfur cathode for baseline (control) and MXene-modified cells consisted of a mixture of SWCNTs, Ketjen Black (EC600JD Lion Specialty Chemicals Company), and Super P (Alfa Aesar H30253-14) conductive carbon sulfur hosts. In contrast, SOA (state of the art) baseline cells consisted of mixtures of Ketjen Black (EC600JD Lion Specialty Chemicals Company), and Super P (Alfa Aesar H30253-14) in the sulfur electrode (i.e., 0 wt % SWCNTs). Overall, a substantial improvement in both capacity and cycle life is achieved with MXene-coated separator cells (1100 mAh/g, ˜85% retention at cycle 110) compared to baseline cells (1100 mAh/g, 68 cycles to 80% capacity retention) and SOA baseline cells (800 mAh/g, 40 cycles to 80% capacity retention). Cycle life results also correlate well with lower and more stable IR values measured for MXene-polymer composite material modified separator cells compared to baseline (prior art) cells, as can be seen in FIG. 8D. This decrease and stabilization of IR values is attributed to blocking of LiPS species by the MXene coating modification, thus inhibiting formation of a thick, resistive solid electrolyte interphase (SEI) at the Li metal anode. Representative voltage discharge profiles, shown in FIG. 8D, demonstrate a high initial discharge capacity (1100 mAh/g) and a two-plateau voltage discharge mechanism that is characteristic of a sulfur-based cathode.

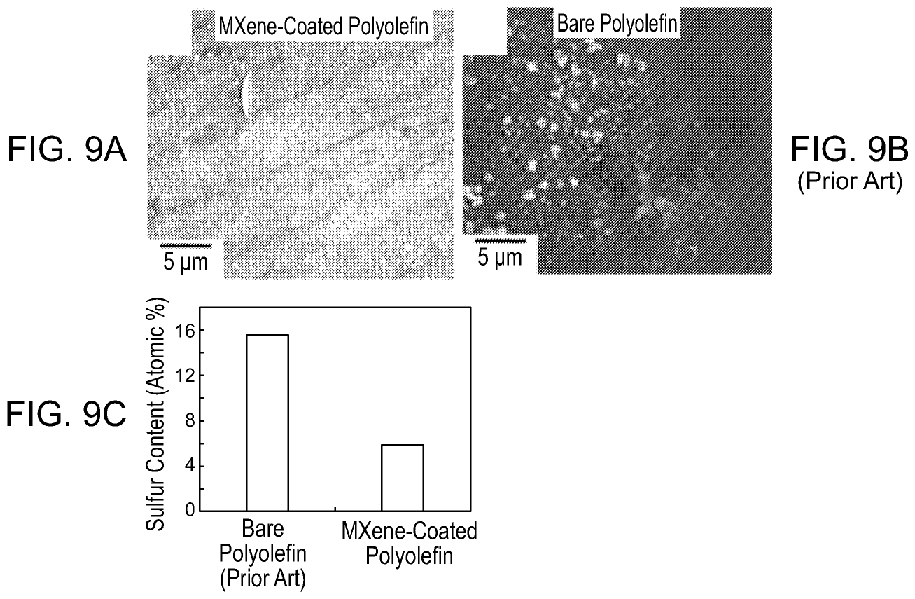

2c. Post-Mortem Analysis of MXenes Coatings on Separators. To understand how LbL MXene modification on the separator improves cycle life performance, we performed post-mortem analysis on cycled, disassembled cells via SEM equipped with energy dispersive X-ray detection capability (EDX), as shown in FIGS. 9A through 9C. A stark difference was observed for cells cycled with MXene-coated polyolefin separators compared to baseline cells with bare polyolefin separators. In contrast to MXene-modified separators, a thick layer of accumulated sulfur species completely blocking the separator pore structure was found in bare polyolefin separators removed from baseline cells. These post-mortem analysis results provide the strongest and most direct evidence supporting our premise that an ultra-thin and ultra-lightweight, conformal LbL MXene coating can drastically reduce the accumulation and migration of polysulfide species generated at the cathode during cell cycling.

2d. Fabrication of MXene-Polymer Coatings on Li—S Electrodes. MXene coatings were deposited onto Li—S electrodes in similar methods to films deposited onto separators. Concentrated MXene solutions were diluted with deionized water (DI) to a concentration of 0.2 mg/ml. PAH in DI was used at a concentration of 0.2 mg/ml. PAH and rinse solutions were pH adjusted to a value of 7.4. Li—S electrodes were plasma treated for 30 seconds to help facilitate LbL buildup. After plasma treatment, electrodes were submerged in PAH solution for 10 minutes, followed by a 5-minute rinsing step in DI. The substrate was then hung vertically and spray coating was used to performed LbL deposition. MXene and PAH solutions were alternately sprayed for 10 seconds each with 10 seconds of rinsing in between until the desired number of bilayers was reached. Up to 40 bilayers was applied to the surface of the electrode.

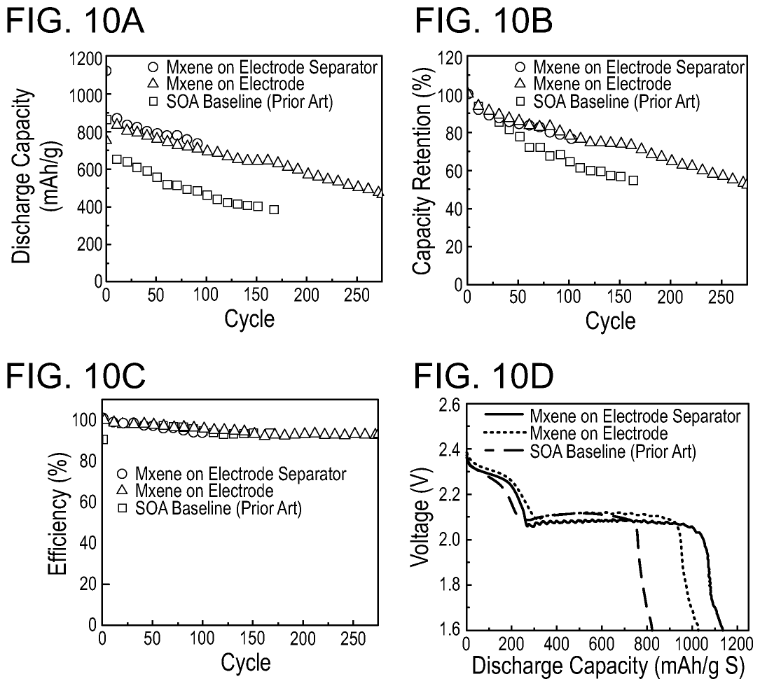

2e. Electrochemical Evaluation of MXene-Polymer Coatings on Electrodes. We evaluated electrochemical performance of MXene coatings on the Li—S electrode as well as potential synergistic effects of combining both MXene-coated separators and sulfur cathodes in the same Li—S cell assembly. Improvements in capacity, cycle retention, and IR were realized over SOA baseline cells, as shown in FIGS. 10A through 10D, thus indicating improved electrochemical stability from LbL MXene modification of the sulfur cathode surface. Cycle efficiency values were also high (>98%) for all cells tested, as can be seen in FIGS. 10A through 10D. Overall, MXene-modified sulfur cathode cells achieved 120 cycles to 80% capacity retention and demonstrated a specific capacity of 600 mAh/g after 225 cycles of long-term testing at a C/2 rate. Combing MXene-modified sulfur cathodes with MXene-modified separator also improves cell performance over the SOA baseline.

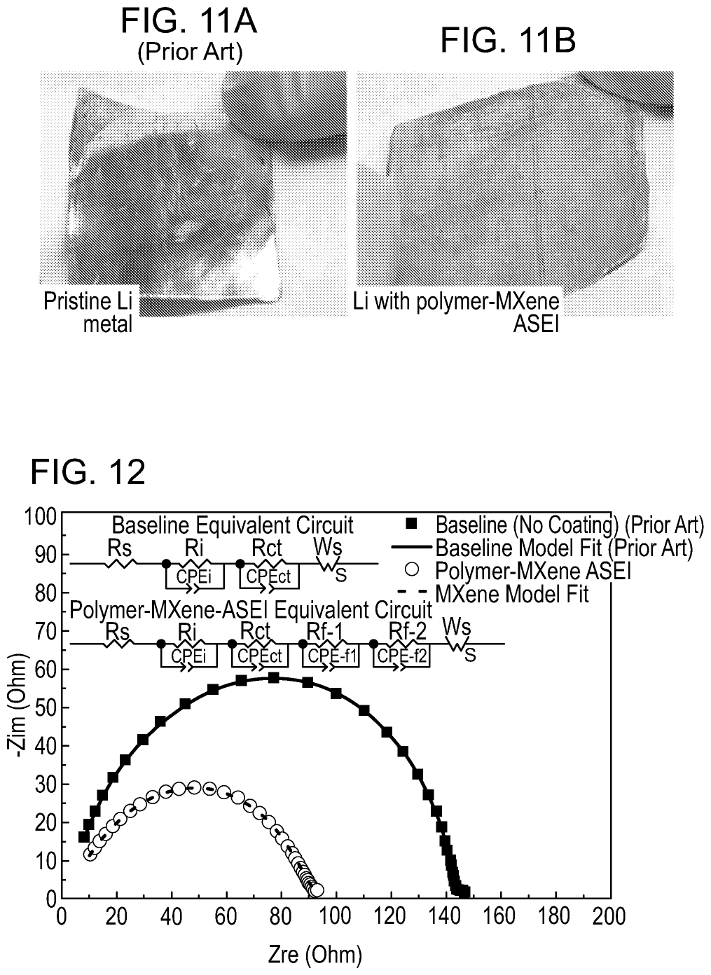

2f. Fabrication of MXene-Polymer Coatings on Li Metal Anodes. Depositing coatings onto Li metal anode presents unique challenges due to the highly reactive nature of Li metal in the presence of water. To apply coatings to the Li metal anode, the coating must first be applied to a separate substrate and then transferred to the Li metal. The LbL film application process was used to deposit a transferrable coating to the Li metal surface. Solutions of PEO and PAA (0.2 mg/ml, pH 2.5) were alternately sprayed onto an FEP surface. Prior to deposition, the FEP was plasma treated for 30 seconds followed by a single dip-coated layer. Up to 24 layers of PEO/PAA were deposited on the FEP via spray coating. After this layer was deposited, the samples were dried at 70° C. for 2 hours. Graphene oxide, MXenes and PAH were each used at a 0.2 mg/ml concentration and pH was balanced to 7.4. First, a layer of GO was deposited followed by a layer of PAH. This layer was necessary to preserve the film integrity during the spraying process. Next, MXene and PAH solutions were alternated, spraying for 10 seconds each time with a 5 second rinse step between. Up to 40 bilayers were deposited. Once finished, the coating was allowed to air-dry overnight. To transfer the film to Li metal, the coating was placed face-to-face with Li metal in an inert environment and sealed inside a foil pouch. This pouch was then fed through a calendar roll press twice to transfer the coating from the FEP substrate to the Li metal surface, as shown in FIG. 2. Images of pristine Li and Li with the MXene film shown in FIGS. 11A and 111B, respectively.

2g. EIS Evaluation of MXene-Polymer Coatings on Li Metal Anodes. EIS measurements were performed on symmetrical cells assembled with either bare Li anode foils or Li metal anode coated with the polymer-MXene ASEI, as shown in FIG. 12. The ASEI consisted of 12 bilayers of PEO/PAA and 12 bilayers of MXene/PAH. Experimental data was fit to an equivalent circuit model as show in the insert of FIG. 12, where Rₛ is solution resistance, Rᵢ is interfacial resistance, R_{ct} is charge-transfer resistance, and Wₛ is the Warburg element. The additional elements in ASEI-modified Li anode cell data, R_{f-1} and R_{f-2}, were added to account for the additional resistance arising from the ASEI/Li and ASEI/electrolyte interfaces. These additional ASEI-specific resistance elements were found to be minimal and did not significantly impact the total cell resistance. Symmetric cells with polymer-MXene ASEI-protected Li showed an interfacial resistance (Rᵢ) of 71Ω, which is significantly less (40% lower) than the Rᵢ (123Ω) measured for symmetric cells assembled with bare Li anodes. We attribute this decrease in interfacial resistance to the formation of a more stable Li electrode/electrolyte interface as a result of the applied ASEI coating.

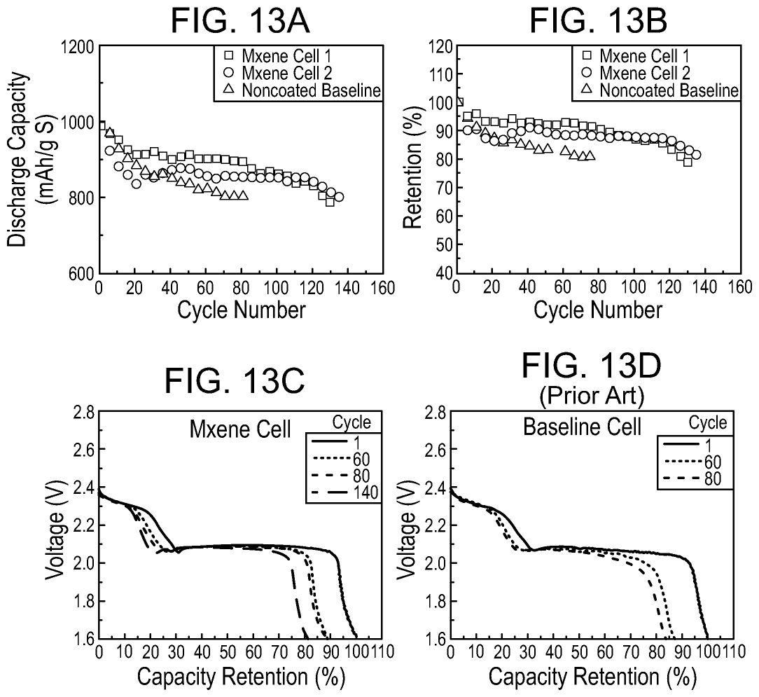

2h. Electrochemical Evaluation of MXene-Polymer Coatings on Li Metal Anodes. Li—S cells were formed by 3 charge-discharge cycles at a C/10 rate, followed by C/4 cycling. Discharge capacity for baseline cells and ASEI-modified Li anode cells are shown in FIGS. 13A through 13D. Baseline cells and cells with ASEI-modified Li anodes achieve >1200 mAh/g S during formation and 1000 mAh/g S during initial C/4 cycling. This result demonstrates that there is no capacity loss penalty after coating Li anodes with our polymer-MXene ASEI. Capacity retention, plotted in FIG. 13B, shows that non-coated baseline cells only achieve 70 cycles to their end-of-life (80% of initial capacity), while polymer-MXene ASEI-protected Li anode cells demonstrated a significant cycle life improvement, achieving 150 cycles to their end-of-life. This performance represents an increase of up to ˜100% by our ASEI Li anode protection approach. Voltage profiles, shown in FIG. 13C, also support stable cycling for ASEI-protected Li anode cells, especially between cycles 20 and 120 where minimal capacity loss is observed. In contrast, voltage profiles for baseline cells, plotted in FIG. 13D, show steady capacity loss from cycle 1 to cycle 80, shortly after which cells reached their end-of-life mark of retention of 80% of the initial capacity.

### REFERENCES

1. Chung, S.-H.; Manthiram, A., Designing Lithium-Sulfur Cells with Practically Necessary Parameters. Joule 2018, 2 (4), 710-724.
2. Zhang, S. S., Problem, Status, and Possible Solutions for Lithium Metal Anode of Rechargeable Batteries. ACS Applied Energy Materials 2018,1 (3), 910-920.
3. Tikekar, M. D.; Choudhury, S.; Tu, Z.; Archer, L. A., Design principles for electrolytes and interfaces for stable lithium-metal batteries. Nature Energy 2016, 1, 16114.
4. Lin, D.; Liu, Y.; Cui, Y., Reviving the lithium metal anode for high-energy batteries. Nature Nanotechnology 2017, 12, 194.
5. Naguib, M.; Mochalin, V. N.; Barsoum, M. W.; Gogotsi, Y., Two-Dimensional Materials: 25th Anniversary Article: MXenes: A New Family of Two-Dimensional Materials (Adv. Mater. July 2014). Advanced Materials 2014, 26 (7), 982-982.
6. Naguib, M.; Kurtoglu, M.; Presser, V.; Lu, J.; Niu, J.; Heon, M.; Hultman, L.; Gogotsi, Y.; Barsoum, M. W., Two-Dimensional Nanocrystals Produced by Exfoliation of Ti3AlC2. Advanced Materials 2011, 23 (37), 4248-4253.
7. Naguib, M.; Mashtalir, O.; Carle, J.; Presser, V.; Lu, J.; Hultman, L.; Gogotsi, Y.; Barsoum, M. W., Two-Dimensional Transition Metal Carbides. ACS Nano 2012, 6 (2), 1322-1331.
8. Ghidiu, M.; Naguib, M.; Shi, C.; Mashtalir, O.; Pan, L. M.; Zhang, B.; Yang, J.; Gogotsi, Y.; Billinge, S. J. L.; Barsoum, M. W., Synthesis and characterization of two-dimensional Nb4C3 (MXene). Chemical Communications 2014, 50 (67), 9517-9520.
9. Tang, H.; Li, W.; Pan, L.; Cullen, C. P.; Liu, Y.; Pakdel, A.; Long, D.; Yang, J.; McEvoy, N.; Duesberg, G. S.; Nicolosi, V.; Zhang, C., In Situ Formed Protective Barrier Enabled by Sulfur@Titanium Carbide (MXene) Ink for Achieving High-Capacity, Long Lifetime Li—S Batteries. 2018, 5 (9), 1800502.
10. Ghidiu, M.; Lukatskaya, M. R.; Zhao, M. Q.; Gogotsi, Y.; Barsoum, M. W., Conductive two-dimensional titanium carbide ‘clay’ with high volumetric capacitance. (1476-4687 (Electronic)).
11. Mashtalir, O.; Naguib M Fau-Mochalin, V. N.; Mochalin Vn Fau-Dall'Agnese, Y.; Dall'Agnese Y Fau-Heon, M.; Heon M Fau-Barsoum, M. W.; Barsoum Mw Fau-Gogotsi, Y.; Gogotsi, Y., Intercalation and delamination of layered carbides and carbonitrides. (2041-1723 (Electronic)).
12. Naguib, M.; Unocic, R. R.; Armstrong, B. L.; Nanda, J., Large-scale delamination of multi-layers transition metal carbides and carbonitrides “MXenes”. Dalton Transactions 2015, 44 (20), 9353-9358.
13. Sang X Fau-Xie, Y.; Xie Y Fau-Lin, M.-W.; Lin Mw Fau-Alhabeb, M.; Alhabeb, M.; Van Aken, K. L.; Gogotsi, Y.; Kent Pre Fau-Xiao, K.; Xiao K Fau-Unocic, R. R.; Unocic, R. R., Atomic Defects in Monolayer Titanium Carbide (Ti(3)C(2)T(x)) MXene. (1936-086X (Electronic)).
14. Shahzad, F.; Alhabeb, M.; Hatter, C. B.; Anasori, B.; Man Hong, S.; Koo, C. M.; Gogotsi, Y., Electromagnetic interference shielding with 2D transition metal carbides (MXenes). (1095-9203 (Electronic)).
15. Harris, K. J.; Bugnet, M.; Naguib, M.; Barsoum, M. W.; Goward, G. R., Direct Measurement of Surface Termination Groups and Their Connectivity in the 2D MXene V2CTx Using NMR Spectroscopy. The Journal of Physical Chemistry C 2015, 119 (24), 13713-13720.
16. Hope, M. A.; Forse, A. C.; Griffith, K. J.; Lukatskaya, M. R.; Ghidiu, M.; Gogotsi, Y.; Grey, C. P., NMR reveals the surface functionalisation of Ti3C2 MXene. Physical Chemistry Chemical Physics 2016, 18 (7), 5099-5102.
17. Karlsson, L. H.; Birch, J.; Halim, J.; Barsoum, M. W.; Persson, P. O., Atomically Resolved Structural and Chemical Investigation of Single MXene Sheets. (1530-6992 (Electronic)).
18. Lipatov, A.; Alhabeb, M.; Lukatskaya, M. R.; Boson, A.; Gogotsi, Y.; Sinitskii, A., Effect of Synthesis on Quality, Electronic Properties and Environmental Stability of Individual Monolayer Ti3C2 MXene Flakes. Advanced Electronic Materials 2016, 2 (12), 1600255-n/a.
19. Peng, Y.-Y.; Akuzum, B.; Kurra, N.; Zhao, M.-Q.; Alhabeb, M.; Anasori, B.; Kumbur, E. C.; Alshareef, H. N.; Ger, M.-D.; Gogotsi, Y., All-MXene (2D titanium carbide) solid-state microsupercapacitors for on-chip energy storage. Energy & Environmental Science 2016, 9 (9), 2847-2854.
20. Zhang, C.; Cui, L.; Abdolhosseinzadeh, S.; Heier, J., Two-dimensional MXenes for lithium-sulfur batteries. InfoMat 2020, 2 (4), 613-638.
21. Wang, X.; Shen, X.; Gao, Y.; Wang, Z.; Yu, R.; Chen, L., Atomic-Scale Recognition of Surface Structure and Intercalation Mechanism of Ti3C2X. Journal of the American Chemical Society 2015, 137 (7), 2715-2721.
22. Rawtani, D.; Agrawal, Y. K., Emerging Strategies and Applications of Layer-by-Layer Self-Assembly. Nanobiomedicine (Rij) 2014, 1, 8-8.
23. Ji, L.; Rao, M.; Zheng, H.; Zhang, L.; Li, Y.; Duan, W.; Guo, J.; Cairns, E. J.; Zhang, Y., Graphene Oxide as a Sulfur Immobilizer in High Performance Lithium/Sulfur Cells. Journal of the American Chemical Society 2011, 133 (46), 18522-18525.
24. Liang, X.; Rangom, Y.; Kwok, C. Y.; Pang, Q.; Nazar, L. F., Interwoven MXene Nanosheet/Carbon-Nanotube Composites as Li—S Cathode Hosts. Advanced Materials 2017, 29 (3), 1603040-n/a.
25. Zhang, X.; Jiang, C.; Cheng, M.; Zhou, Y.; Zhu, X.; Nie, J.; Zhang, Y.; An, Q.; Shi, F., Facile Method for the Fabrication of Robust Polyelectrolyte Multilayers by Post-Photo-Cross-Linking of Azido Groups. Langmuir 2012, 28 (18), 7096-7100.
26. Richardson, J. J.; Cui, J.; Björnmalm, M.; Braunger, J. A.; Ejima, H.; Caruso, F., Innovation in Layer-by-Layer Assembly. Chemical Reviews 2016, 116 (23), 14828-14867.
27. Park, S.; Han, U.; Choi, D.; Hong, J., Layer-by-layer assembled polymeric thin films as prospective drug delivery carriers: design and applications. Biomaterials Research 2018, 22 (1), 29.
28. Sun, Q.; Lee, S. J.; Kang, H.; Gim, Y.; Park, H. S.; Cho, J. H., Positively-charged reduced graphene oxide as an adhesion promoter for preparing a highly-stable silver nanowire film. Nanoscale 2015, 7 (15), 6798-6804.
29. Zhu, H.; Gao, L.; Jiang, X.; Liu, R.; Wei, Y.; Wang, Y.; Zhao, Y.; Chai, Z.; Gao, X., Positively charged graphene oxide nanoparticle: precisely label the plasma membrane of live cell and sensitively monitor extracellular pH in situ. Chemical Communications 2014, 50 (28), 3695-3698.
30. Kudaibergenov, S.; Bakranov, N., Layer-by-Layer Thin Films and Coatings Containing Metal Nanoparticles in Catalysis. 2017.
31. Hwang, J.-Y.; Eltohamy, M.; Kim, H.-W.; Shin, U., Self Assembly of Positively Charged Carbon Nanotubes with Oppositely Charged Metallic Surface. Applied Surface Science 2012, 258, 6455-6459.
32. Lee, D.; Cui, T., Layer-by-Layer Self-Assembly of Single-Walled Carbon Nanotubes with Amine-Functionalized Weak Polyelectrolytes for Electrochemically Tunable pH Sensitivity. Langmuir 2011, 27 (7), 3348-3354.

The relevant teachings of all patents, patent applications, and publications, including all references cited herein and above, are incorporated herein by reference in their entirety. The relevant teachings of “Electrolytes of Rechargeable Lithium-Sulfur Batteries and Lithium-Sulfur Batteries Including the Same,” by Castro Laicer, Pavithra Murugaval Shanthi, and Katherine Harrison, Attorney Docket No.: GIN-00325, filed on Apr. 14, 2022, are also incorporated by reference in their entirety.

1. An electrochemical device, comprising:
a) a cathode;
b) an anode;
c) a separator between the cathode and the anode; and
d) an electrolyte in fluid communication with the cathode, the anode, and the separator,
wherein at least one of the cathode, the anode, and the separator is coated with at least one of a blend and a multilayer film of an MXene-polymer composite material.

2. The electrochemical device of claim 1, wherein the electrochemical device is selected from the group consisting of a lithium-sulfur battery, a lithium-metal battery, a lithium-ion battery, a sodium-sulfur battery, a magnesium-sulfur battery, an aluminum-sulfur battery, a lithium-air battery, and a capacitor.

3. The electrochemical device of claim 1, wherein the anode is selected from the group consisting of a graphitic carbon anode, a silicon anode, a lithium metal anode, a lithium alloy anode, a sodium metal anode, a magnesium metal anode, and an aluminum metal anode.

4. The electrochemical device of claim 1, wherein the anode includes the MXene-polymer composite material.

5. The electrochemical device of claim 4, wherein the MXene-polymer composite material of the anode is a blend of MXene and polymer components of the MXene-polymer composite material coating.

6. The electrochemical device of claim 4, wherein the MXene-polymer composite material of the anode includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member of the group consisting of carbon and nitrogen, and Tₓ is at least one surface functional groups selected from the group consisting of an alkoxide, a carboxylate, a halide, a hydroxide, a hydride, an oxide, a sub-oxide, a nitride, a sub-nitride, a sulfide, and a thiol.

7. The electrochemical device of claim 6, wherein the MXene-polymer composite material of the anode includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, Ta₄C₃Tₓ, and Mo₂Ti₂C₃Tₓ.

8. The electrochemical device of claim 4, wherein the MXene-polymer composite material of the anode includes at least one member of the polymer group consisting of a poly(acrylic acid), poly(styrene sulfonate), poly(ethylene oxide), branched poly(ethyleneimine) linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

9. The electrochemical device of claim 4, wherein the MXene-polymer composite material od the anode includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

10. The electrochemical device of claim 4, wherein the MXene-polymer composite material of the anode includes a crosslinked polymer.

11. The electrochemical device of claim 1, wherein the cathode includes the MXene-polymer composite material.

12. The electrochemical device of claim 11, wherein the MXene-polymer composite material of the cathode is a blend of MXene and polymer components of the MXene-polymer composite material.

13. The electrochemical device of claim 11, wherein the MXene-polymer composite material of the cathode includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol.

14. The electrochemical device of claim 13, wherein the MXene-polymer composite material of the cathode includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

15. The electrochemical device of claim 11, wherein the MXene-polymer composite material of the cathode includes at least one member of the group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

16. The electrochemical device of claim 11, wherein the MXene-polymer composite material of the cathode includes at least one of graphene oxide, single-walled carbon nanotubes, multi-walled carbon nanotubes, SiO₂, and inorganic nanoparticles including at least one member of the group consisting of SiO₂, TiO₂, ZnO, Al₂O₃, CeO₂, Fe₂O₃, Fe₃O₄, and Al(OH)₃.

17. The electrochemical device of claim 11, wherein the MXene-polymer composite material of the cathode includes a crosslinked polymer.

18. The electrochemical device of claim 1, wherein the cathode includes an MXene and at least one sulfur component, and wherein the combination of the MXene and the at least one sulfur component are distinct from the MXene-polymer composite material.

19. The electrochemical device of claim 18, wherein the MXene of the cathode has a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol.

20. The electrochemical device of claim 19, wherein the MXene of the cathode includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

21. The electrochemical device of claim 1, wherein the cathode includes an MXene, and the MXene is distinct from the MXene polymer-composite material.

22. The electrochemical device of claim 21, where in the MXene of the cathode has a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol.

23. The electrochemical device of claim 22, wherein the MXene of the cathode includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

24. The electrochemical device of claim 1, wherein the separator includes the MXene-polymer composite material.

25. The electrochemical device of claim 24, wherein the MXene-polymer composite material of the separator is a blend of MXene and polymer components of the MXene-polymer composite material.

26. The electrochemical device of claim 25, wherein the MXene-polymer composite material on the separator includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member of the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol.

27. The electrochemical device of claim 26, wherein the MXene-polymer composite material of the separator includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

28. The electrochemical device of claim 25, wherein the MXene-polymer composite material of the separator includes at least one member of the polymer group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

29. The electrochemical device of claim 25, wherein the MXene-polymer composite material of the separator includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

30. The electrochemical device of claim 25, wherein the MXene-polymer composite material of the separator includes a crosslinked polymer.

31. The electrochemical device of claim 1, wherein the composite material includes a blend of the MXene and polymer components of the MXene-polymer composite material.

32. The electrochemical device of claim 31, wherein at least two of the anode, the cathode, and the separator include the MXene and the polymer components of the MXene-polymer composite material.

33. The electrochemical device of claim 31, wherein the composite material includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member selected from the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol.

34. The electrochemical device of claim 33, wherein the composite material includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

35. The electrochemical device of claim 31, wherein the composite material includes at least one member of the polymer group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-elhyienledioxytlhiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene chloride, poly(vinylidene fluoride-hexafluoropropylene), and copolymers thereof.

36. The electrochemical device of claim 31, wherein the composite material includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

37. The electrochemical device of claim 31, wherein the composite material includes a crosslinked polymer

38. The electrochemical device of claim 1, wherein at least two of the anode, the cathode, and the separator includes the MXene-polymer composite material.

39. The electrochemical device of claim 38, wherein the composite material of the anode, the cathode, and the separator each independently includes at least one nanosheet of MXenes with a general formula of Mₙ₊₁XₙTₓ (n=1, 2, or 3), where M represents a transition metal selected from a Group IIIB metal, Group IVB metal, Group VB, or Group VIB metal, X is at least one member of the group consisting of carbon and nitrogen, and Tₓ is at least one surface functional group selected from the group consisting of an alkoxide, a carboxylate, a halide, a hydroxide, a hydride, an oxide, a sub-oxide, a nitride, a sub-nitride, a sulfide, and a thiol.

40. The electrochemical device of claim 39, wherein the composite of at least one of the anode, the cathode, and the separator each independently includes at least one member of the group consisting of Ti₂CTₓ, Ti₃C₂Tₓ, and Nb₄C₃Tₓ, V₂CTₓ, Nb₂CTₓ, Mo₂CTₓ, (Ti,V)₂CTₓ, (Ti,Nb)₂CTₓ, (Ti,V)₃C₂Tₓ, Ti₃CNTₓ, Zr₃C₂Tₓ, (Cr,V)₃C₂Tₓ, Cr₂TiC₂Tₓ, Mo₂TiC₂Tₓ, Ti₄N₃Tₓ, (Nb,Ti)₄C₃Tₓ, (Nb,Zr)₄C₃Tₓ, and Ta₄C₃Tₓ, Mo₂Ti₂C₃Tₓ.

41. The electrochemical device of claim 38, wherein the composite material of at least one of the anode, the cathode, and the separator each independently includes at least one member of the polymer group consisting of a poly(acrylic acid), poly(styrene sulfonate), poly(ethylene oxide), branched poly(ethyleneimine) (PEI), linear poly(ethyleneimine), poly(allylamine hydrochloride), perfluorosulfonic acid, poly(diallyldimethylammonium chloride), polyaniline, polyvinyl alcohol, poly(3,4-ethylenedioxythiophene), poly(acrylic acid-ran-vinylbenzyl acrylate), polylysine, hyaluronic acid, chitosan, poly(vinyl sulfate), dextran sulfate, poly(methyl methacrylate), poly(diallyldimethyl ammonium) chloride, polyvinylidene fluoride, poly(vinylidene fluoride-hexafluoropropylene), and copolymers thereof.

42. The electrochemical device of claim 38, wherein the MXene-polymer composite material of at least one of the anode, the cathode, and the separator each independently includes at least one of graphene oxide, single-walled carbon nanotubes, multi-walled carbon nanotubes, and inorganic nanoparticles including at least one member of the group consisting of SiO₂, TiO₂, ZnO, Al₂O₃, CeO₂, Fe₂O₃, Fe₃O₄, and Al(OH)₃.

43. The electrochemical device of claim 38, wherein the MXene-polymer composite material of at least one of the anode, the cathode, and the separator each independently includes a crosslinked polymer.
